(19) United States
(12) Patent Application Publication
(10) Pub. No.: US 2019/0053478 A1
(43) Pub. Date: Feb. 21, 2019

(54) FISHING POLE WITH LED FLASHLIGHT INTEGRATED IN HANDLE

(71) Applicants: Seth Thomas Valdivia, Aberdeen, MD (US); Scott William Valdivia, Aberdeen, MD (US)

(72) Inventors: Seth Thomas Valdivia, Aberdeen, MD (US); Scott William Valdivia, Aberdeen, MD (US)

(21) Appl. No.: 15/678,793

(22) Filed: Aug. 16, 2017

(51) Int. Cl. A01K 87/00; F21L 4/08; F21V 33/00; F21V 23/04; F21V 5/04; F21V 31/00

(52) U.S. Cl. CPC A01K 87/007; F21L 4/08; F21V 33/008; F21Y 2115/10; F21V 5/04; F21V 31/00; F21V 23/0414

(57) ABSTRACT

A fishing pole incorporating a light source in the handle. The handle has a hollow section forming a housing for receiving a light source so as to axially emit a light beam opposite toward the rear of the handle. The light source includes a lens, a bulb section, a control section, and a battery section and is water resistant against water immersion. The control section includes an on/off switch. The light source comprises an LED with at least a 100 lumens output.

### CROSS-REFERENCE TO RELATED APPLICATION(S)

Not applicable

### BACKGROUND OF THE INVENTION

### 1. Field of Invention

The present invention relates to the field of fishing poles, more particularly to a fishing pole having an integrated light.

### 2. Description of Related Art

Although most fisherman fish primarily during daylight hours, night fishing is a past time many enjoy as well. Additionally, many fisherman will be out fishing from a boat and only return to shore as the sun is setting or will embark on their fishing excursion during darkness. Additionally, fisherman can be stranded on the water at night as their boat suffers engine malfunctions, if they are caught in a storm.

Fisherman out in open lake or ocean waters can become stranded during night hours or need light for fishing activities such removing caught fish from a hook, changing lures, or baiting hooks.

Based on the foregoing, there is a need for a light source able to provide illumination and a location beacon/signal in an emergency.

### SUMMARY OF THE INVENTION

In an embodiment, a fishing pole incorporates a light source and comprises a fishing pole having a handle and a shaft with the handle forming a housing for receiving a light source within so as to axially emit a light beam opposite from the shaft. The light source includes a lens, a light bulb section, a control section, and a battery section, and exhibits water-resistance against water immersion, at least when in the handle. The control section includes an on/off switch, and the light source generates at least 100 lumens.

In an embodiment, the lens and bulb section output can be configured to include at least one of a) a fixed beam output, b) a focused beam output, and c) adjustable beam output. The lens can be separate from the light bulb section or structurally incorporated into the light bulb section.

In an embodiment, the battery section includes a lithium-based battery.

In an embodiment, the light source includes a recharging port for recharging the battery.

In an embodiment, the recharging port can accommodate a USB charging input.

In an embodiment, the light bulb section includes a LED.

In an embodiment, an LED can generate a 1000 lumens light beam.

In an embodiment, the control section can output a light strobe or SOS signal.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side view of the fishing pole with an integrated light source, according to an embodiment of the present invention;

FIG. 2 is a cutaway view of the handle showing a light source, or flashlight, incorporated in the fishing pole according to an embodiment of the present invention;

FIG. 3 is a sideview of a light source for incorporating into the handle of the fishing pole according to an embodiment of the present invention; and

FIG. 4 is an exploded view of the light source of FIG. 3 according to an embodiment of the current invention.

### DETAILED DESCRIPTION OF PREFERRED EMBODIMENTS

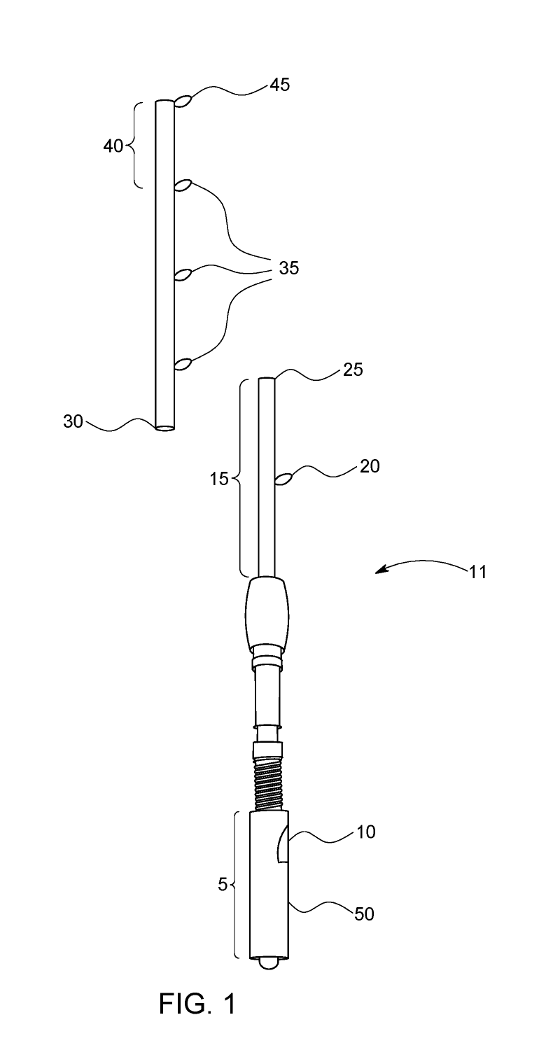

Preferred embodiments of the present invention and their advantages may be understood by referring to FIGS. 1-4, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, fishing pole 1 can consist of handle 5, reel seat 10, a shaft 15, a hook keeper 20, a female ferrule 25, a male ferrule 30, guides 35, a tip 40, and a tip top 45. The male ferrule 30 and the female ferrule 25 can provide a coupling to assemble the two halves of the fishing pole together for use. Incorporated in handle 5 is a light source 50, which can comprise a flashlight structurally integrated as part of the handle 5 or separately inserted into a housing created by a hollow handle 5 constructed to receive an inserted light source 50.

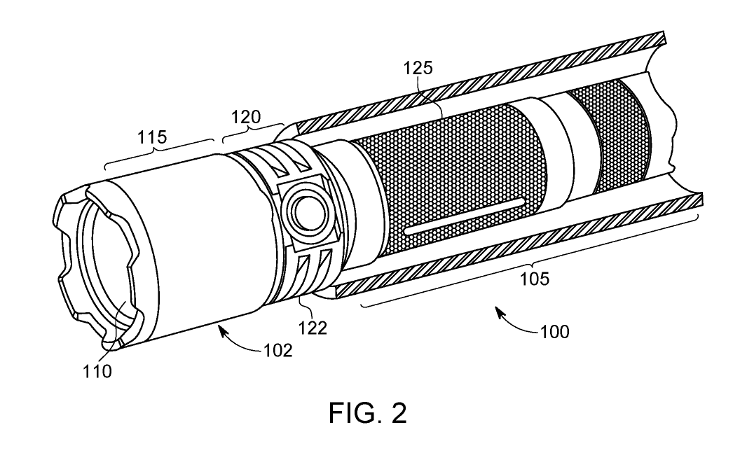

Turning to FIG. 2, as depicted a cutaway handle 100 (corresponding to handle 5 in FIG. 1) incorporates a flashlight 102 as the light source 50. As shown, handle 105 allows for receipt of a flashlight 102 into a hollow section forming a housing for incorporating the flashlight 102 into the fishing pole 1.

Flashlight 102 can include a lens 110 for focusing and varying a light beam emitted by flashlight 102. The bulb section 115 can include either a light bulb, or preferably, an LED to generate a light beam. A control section 120 can include a control circuit with a manual control 122. In an embodiment, the manual control section 122 can provide an on/off switch position for turning on and off illumination emission as well as a strobe switch position to generate a strobe light emission for signaling in the event of an emergency. Battery section 125 can house the power source for the flashlight 102. The flashlight 102 can also include a battery charging port for receiving a battery charging power input. As depicted, the light source 50 can fit into handle 105 with an emitted beam from the lens 110 extending axially from the handle 105 directed from the handle 105 opposite from tip top 45. The light source 50 can also be shock resistance and water-proof against submersion. It is contemplated that light source 50 when incorporated into handle 105 can be at least water-resistant against immersion. Further, as can be readily appreciated, any light source 50 may comprise a lens 110, a bulb section 115, a control section 120, and battery section 125, and these functional components do not imply that the embodiments of light source 50 apply to only a flashlight 102.

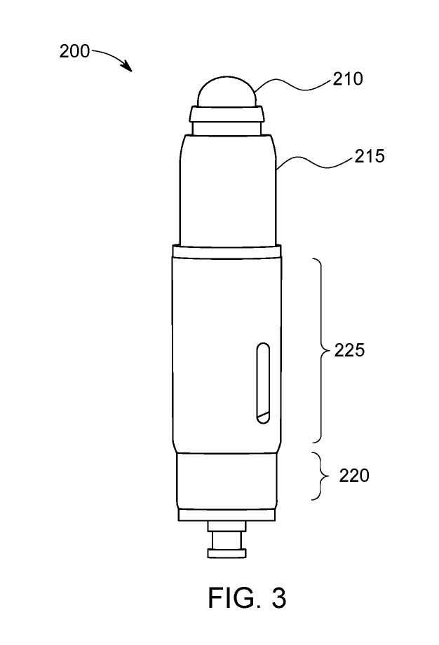

Referring to FIG. 3, the depicted light source 200 can be used a light source 50 as depicted in FIG. 1 according to an embodiment of the invention. As shown, light source 200 can comprise a lens 210, a bulb section 215, a battery section 225, and a control section 220. Control section 220 can incorporate a simple spring-loaded push-button switch 222 to turn light source 200 of and on. The depicted light source 200 can be much smaller than flashlight 102 depicted in FIG. 2, and in one embodiment of light source 200, the length of light source 200 can have a length of approximately 1″. When assembled in a handle 5 of fishing pole 1, switch 222 can be mounted so as allow a small amount of back and forth motion of light source 200 within the handle 5 sufficient to activate switch 222.

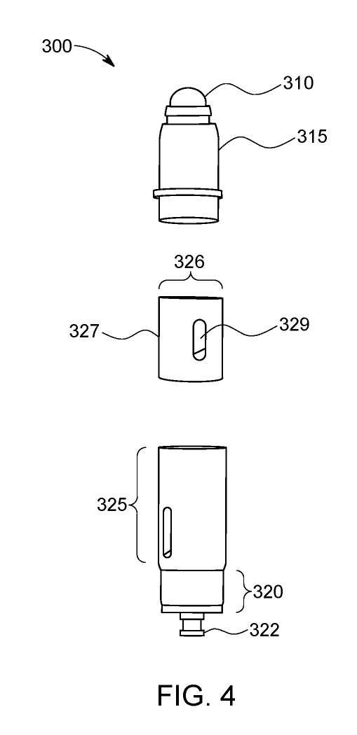

As depicted in FIG. 4, light source 200 in FIG. 3 is depicted in an expanded view 300 breaking down light source 200 into its component sections. Expanded view 300 shows bulb section 315 separated from battery section 325. Bulb section 315 can include lens 310. Battery section 325 as shown can be structurally incorporated along with control section 320, which can include spring-loaded push-button switch 322. The exploded view 300 as depicted shows a battery pack 326, which can consist of a battery housing 327 housing a plurality of AAAA, watch, or hearing aid batteries 329. Battery pack 326 can fit within battery section 325 to power a light bulb in light bulb section 315 as selected by switch 322. The batteries 329 can be lithium-based, nickel-cadmium based, alkaline-based, or other types of dry cell batteries.

LED (light-emitting diode) technology as well as battery efficiency have resulted in flashlights that are smaller, lighter and brighter compared to ones from just a few years ago. These newer flashlights provide improved light output, flexible and improved battery type and run time, smaller size and weight, and cheaper prices. Rechargeable batteries are available and the light source 50 can incorporate such features such as impact-resistance, water-resistance, heat dissipation, and multiple lighting modes.

In some preferred embodiments, an LED comprising bulb section 115 can provide a powerful light beam of 1000 lumens or more. In some embodiments, beam intensity may be controlled by the control section 120 for different applications. An exemplary range of output can vary from 10 lumens to 1000 lumens to distances as much as about 300 meters or more, and this output may be adjustable by the user. Depending on the beam intensity setting, battery life can run from a couple of hundred hours at a low setting to just a few hours at the highest setting. In a preferred embodiment, the light source 50 can output at least 100 lumens. In other embodiments, the light source 50 can generate at least 1000 lumens. In yet other embodiments, light source 50 can generate a light beam greater than 1000 lumens.

As to bulb type, LED bulbs offer superior performance and versatility, allowing for superior energy efficiency, run time, impact resistance, and brightness options.

In some embodiments, lens 110 can control how the light is dispersed, and configurable options can include a fixed, single beam width, a focused, single beam forming a spotlight for long distance projection, and adjustable for varying beam width from wide to focused, or any point in-between. The lens 110 can also be structurally incorporated as part of the LED in bulb section 115.

Battery types can include disposable batteries such as AAA, AA, or CR123A. CR123A can offer advantages of a higher voltage output for a smaller size and weight, allowing for a brighter flashlight in a smaller, lighter package. Other even smaller batteries allow for a very compact design incorporated into the handle 5, such as the batteries depicted in FIG. 3 and FIG. 4. The battery types can include AAAA, watch, or hearing aid batteries that are lithium-based, nickel-cadmium based, alkaline-based, or other types of dry cell batteries. Rechargeable batteries, such as lithium-ion batteries, can be made rechargeable through a USB connection from a computer, AC or DC outlet, or solar panel. An adapter can allow for recharging from a car power port.

The light source 50 can further include a strobe mode or even automatic SOS feature. Control section 120 can provide an on/off and lighting mode switch for selecting strobe or SOS operation. Push buttons and slide switches are typically thumb operated. A rotating bezel can also serve as a switch, but requires two hands to operate. The switch can also operate by tapping light source 50 to slightly depress the light source 50 activating a switch to power light source 50 on and off.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A fishing pole incorporating a light source, comprising:
a fishing pole having a handle and a shaft;
said handle forming a housing for receiving a light source within so as to axially emit a light beam opposite from the shaft;
wherein the light source includes a lens, a light bulb section, a control section, and a battery section, and exhibits water-resistance against water immersion at least when in the handle; and
wherein the control section includes an on/off switch; and
wherein the light source generates at least 100 lumens.

2. The fishing pole of claim 1, wherein the lens and light bulb section output can be configured to include at least one of—
a) fixed beam output;
b) focused beam output;
c) adjustable beam output; and
said lens can be separate from the light bulb section or structurally incorporated into the light bulb section.

3. The fishing pole of claim 1, wherein the battery section includes a lithium-based battery.

4. The fishing pole of claim 1, wherein the light source includes a recharging port for recharging a battery comprising the battery section.

5. The fishing pole of claim 4, wherein the recharging port can accommodate a USB charging input.

6. The fishing pole of claim 1, wherein the light bulb section includes a LED.

7. The fishing pole of claim 6, wherein the LED can generate at least a 1000 lumens light beam.

8. The fishing pole of claim 1, wherein the control section can select a strobe or SOS operation.

9. The fishing pole of claim 1, wherein the handle structurally incorporates the light source.

10. The fishing pole of claim 1, wherein the light source comprises a flashlight housed in the handle.
